(19) United States
(12) Patent Application Publication
(10) Pub. No.: US 2004/0266478 A1
(43) Pub. Date: Dec. 30, 2004

(54) Wireless phone adapter

(76) Inventors: Anthony G. King, Huntington Woods, MI (US); Francis King, Bloomfields Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/608,920

(22) Filed: Jun. 27, 2003

(51) Int. Cl. H04M 1/00

(52) U.S. Cl. 455/557; 455/554.2

(57) ABSTRACT

A bridging adapter connects a wireless phone to a standard telephone line network to allow land-line based telephone system within structures to translate command functions and audio signals between the wireless phone and any land-line telephones on the phone line network. The bridging adapter may also be used with extendable multi-handset systems where multiple handsets communicate over radio frequencies with a base station. The bridging adapter allows land-line telephones or handsets to access all functions and services of a wireless phone connected to the adapter, and conversely allow the wireless phone to use the unique functions of a land-line based telephony network.

### TECHNICAL FIELD

This present invention relates to wireless phones, and more particularly to an adapter designed to bridge wireless phones with a conventional wired phone network.

### BACKGROUND OF THE INVENTION

Definitions

Structures: buildings, including, but not limited to, industrial, commercial, and residential structures.

Telephony Wiring: a wiring system contained with the walls of structures, which includes, but are not limited to two wire ring/tip system, alternating current system carrying voice signals, used for transmission and receiving audio sounds for telephone services.

Telephony jacks: connectors that link the land-line telephones to the telephony wiring.

Telephony jacks include, but not limited to, standard RJ11 connectors.

As wireless telephone services decrease in price and increase in functionality, they are surpassing traditional land-line telephone service in function and even reliability. Most structures contain telephony wiring within the walls which relate to a telephony network connected to the outside world by a line from a local phone service provider. All land-line telephones are connected via telephony jacks to this telephony network. They communicate via this local phone service provider, which processes a call request from or a call answer to this local phone by appropriately making the necessary circuit switches to connect between the communicating parties. The wireless phone service provider also accomplishes similar circuit switches to process call requests and call answers on wireless phones. In fact, wireless and land-line based telephony companies accommodate the circuit switches between them so that wireless and land-line phones can communicate with each other.

A typical wireless phone is designed as a single person phone to be carried and used by the said person within the cellular phone broadcast zone. Such a wireless phone, however, is not always suitable for use within structures or use by a plurality of persons within a structure. It is not suitable for use within structures because the wireless phone, though small and light, is still not convenient to be carried around in a structure all the time. Within a given structure, there could be areas inside the structure, e.g. in an underground basement, where the wireless signal to and from the service provider is not strong enough for acceptable performance of the wireless phone. Also within a structure, there could be numerous people that would like to use the same wireless phone and service, all at the same time or at different times. Because of these deficiencies in wireless phones, land-line phones are still the preferred choice for many structures due to their connection reliability and convenience.

There is a desire for a system that allows user to access the enhanced functions offered by wireless phones while preserving the advantages of land-line phones.

### SUMMARY OF THE INVENTION

The invention relates to a method and system for connecting a wireless phone to land-line telephones, thereby enabling each phone to take advantage of the unique and/or enhanced functions of the other. One embodiment connects land-line telephones normally used for land-based telephone service to a wireless phone via an adapter acting as a bridge between the wireless phone and any telephony jack within a structure. The adapter allows land-line telephones connected through the telephony wiring network containing the telephony jack within structures to access all functions and services of the wireless phone. Another embodiment uses an adapter that connects the wireless phone to an extendable multi-handset system, providing access to the functions and services of the wireless phone from any remote phone in the extendable multi-handset system. A third embodiment combines the first and second embodiments, and uses an adapter that connects the wireless phone to both an extendable multi-handset system and land-line telephones through the telephony wiring network. This embodiment retains all the functionality of both the first and the second embodiments.

By providing an adapter that links a wireless phone with land-line telephones, the invention allows land-line phones to take advantage of the enhanced features offered by wireless phone services while preserving the convenience and reliability of land-line phones. Similarly, the wireless phone can take advantage of the unique function of the land-line telephones.

### BRIEF DESCRIPTION OF THE DRAWINGS

FIG. 1 is a representative diagram illustrating an operating environment according to one embodiment of the invention;

FIG. 2 is a block diagram illustrating an adapter used in the system shown in FIG. 1;

FIG. 3 is a representative diagram illustrating an operating environment of another embodiment of the invention; and

FIG. 4 is a block diagram illustrating an adapter used in the system shown in FIG. 2.

### DETAILED DESCRIPTION OF THE EMBODIMENTS

As is known in the art, current land-line telephone systems consist of two types. Traditional land-line telephones are each connected to individual telephony jacks to connect to the structure's telephony wiring network. More advanced land-line telephones, known as multi-handset extendable phone systems, have multiple handsets. These handsets communicate via radio frequency signals to a base station, which is in turn connected to a telephony jack.

The first embodiment of the invention connects land-line telephones to a wireless phone, allowing any land-line telephones to access the features and functions of the wireless phone. All functions of the wireless phone may be activated from any lane-line telephone by translating touch-tone or voice or other signals into a signal or signals that the wireless phone can recognize and thereby activate the relevant functions. Any feature currently existing on land-line telephones can be retained by this connection method and be used by the wireless phone as well.

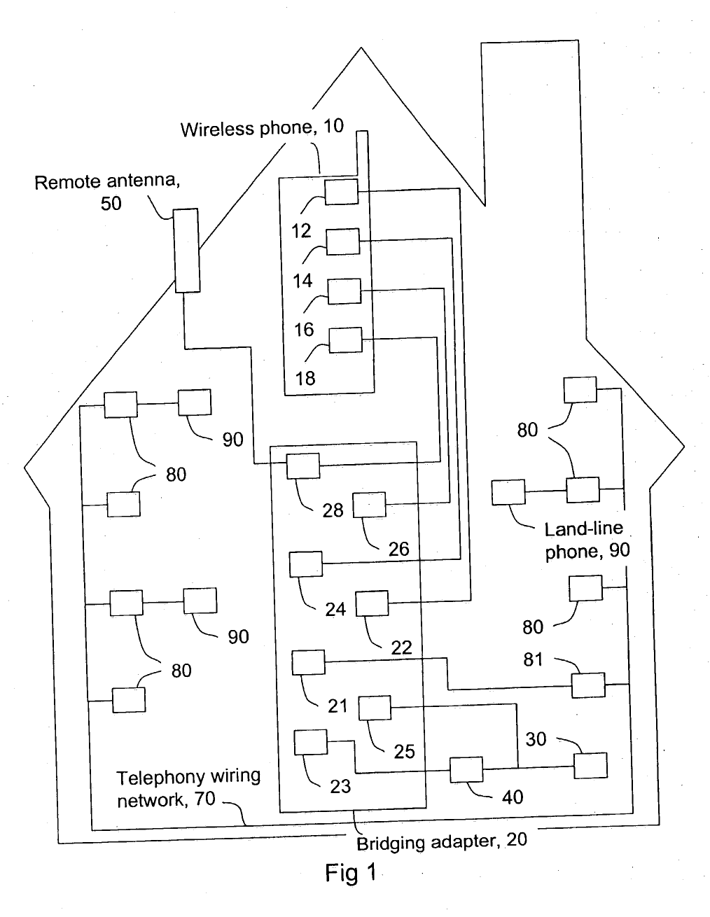

FIG. 1 illustrates one embodiment of the invention where one or more land-line telephones 90 are connected to a wireless phone 10 within a structure. The land-line telephones are connected through telephony jacks 80. The telephony jacks 80 are inter-connected through a normal telephony wiring network 70 within a structure. An adapter 20 bridges the gap between the wireless phone and any land-line telephones through another telephony jack 81 on the telephony wiring network 70.

The wireless phone 10 is connected to the bridging adapter 20 via the wireless phone audio port 12 and control port 14. If the wireless phone 10 is equipped with wireless command and audio communication function, the connection between the wireless phone 10 and the adapter 20 can also be accomplished by a wireless communication link 16. In one embodiment, wireless communication can be established via any known standard, such as Bluetooth or 802.11.

The bridging adapter 20 may also contain an external antennae adapter 28 that is attached to the wireless phone 10 via an antennae port 18 on the phone 10. This antenna adapter 28 is connected by hardwire to an external antenna 50 which can be placed anywhere to improve the indoor reception of the wireless phone 10. By connecting the wireless phone 10 through its antennae port 18 to the antenna adapter 28, reception and clarity of service to the wireless phone can be enhanced through the usage of the external antenna 50.

The bridging adapter 20 connects to the wireless phone 10 via the audio connector 22 and control connector 24. Wireless communication is available through wireless communicator 26. The bridging adapter 20 connects to the telephony wiring network 70 via port 21. Power to the bridging adapter is provided from an external electrical source 30, e.g. the normal electrical supply within a structure via the power input plug 25, and/or from internal batteries 23, which can be recharged through an external charger 40. The external charger would require an external electrical source 30.

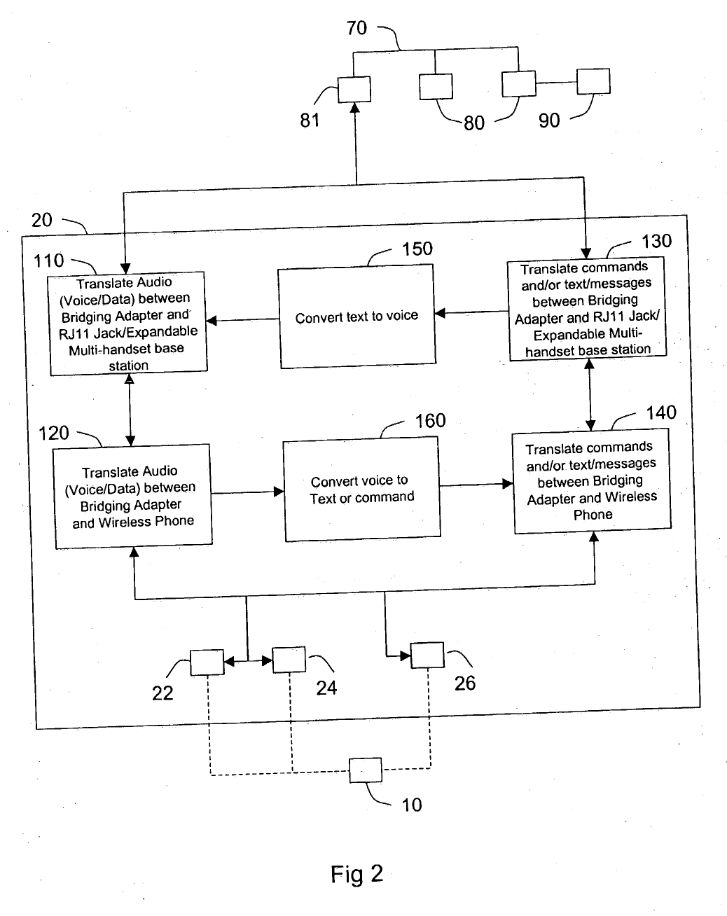

One embodiment of the bridging adapter 20 contains six separate functions as illustrated in FIG. 2. Note that for this embodiment and the other embodiments described below, not all six functions need to be included in the system. A system designer may select any or all of the functions, in any combination, without departing from the scope of the invention.

The first function 110 translates audio (voice/data) signals between telephony jack 81 within a structure and the bridging adapter 20. This function 110 allows the translation of audio (voice/data) signals to and from any land-line telephones 90 that are connected to any telephony jacks 80 which are interconnected to telephony jack 81 via the telephony wiring network 70.

The second function 120 translates audio (voice/data) signals between the bridging adapter 20 and the wireless phone 10. The wireless phone 10 is connected to the bridging adapter 20 through either hardwire connections via audio port 22 and control port 24 or through wireless connection via wireless port 26. This function 120 allows the translation of audio (voice/data) signals to and from any wireless telephone 10.

Audio signals from either function 110 or function 120 travel back and forth in real time in simplex or full duplex. This movement of audio signals between function 110 and function 120 provides audio communication between the wireless phone 10 and any land-line telephones 90.

The third function 130 translates commands and/or text/messages between the land-line telephony jack 81 and the bridging adapter 20. The plurality of commands includes but is not limited to ring function, caller ID display, message notification, dialing sequence activation, standard numerical dial tones, voice dialing, phone book search, phone number storage, phone answering, voicemail access, short messaging access, and termination of communication connection. The plurality of commands may include commands from the entire set or any subset of the available land-line telephone or wireless phone functions. This function 130 allows the translation of commands to activate, or communicate text to, land-line telephones 90 that are connected to any telephony jacks 80 which are interconnected to telephony jack 81 via the telephony wiring network 70. This function 130 also allows the translations of commands and/or text/messages from the land-line telephones 90. This function 130 also allows activation by and usage of the land-line telephones 90 via the bridging adapter 20.

The fourth function 140 translates commands between the wireless phone 10 and the bridging adapter 20. The wireless phone 10 is connected to the bridging adapter 20 through either hardwire connections via audio port 22 and control port 24 or through wireless connection via wireless port 26. Such plurality of commands includes, but is not limited to, ring function, caller ID display, message notification, dialing sequence activation, standard numerical dial tones, voice dialing, phone book search, phone number storage, phone answering, voicemail access, short messaging access, and termination of communication connection. The plurality of commands would include commands from the entire set or any subset of the available in-home phone or wireless phone functions. This function 140 allows the translation of commands to activate, or communicate text to, the wireless phone 10. This function 140 also allows the translations of commands and/or text/messages from the wireless phone 10. Commands and/or text/messages travel back and forth in real time between function 130 and function 140. This movement of commands and text/messages provides the operational commands and the passing of text/messages between the wireless phone 10 and the in-home phones 90.

The fifth function 150 converts text/messages from function 130 to voice and sends the voice to function 110 for translation to in-home phones 90. This function 150 can use text-to-voice technology to audibly transmit text/messages for in-home phones 90 that cannot directly handle display of text/messages.

The sixth function 160 converts voice commands from function 120 to text or digital command and sends the commands to function 140 for translation to wireless phone 10. This function 160 can use voice recognition technology to translate audio/voice commands to digital commands that can be understood by the wireless phone.

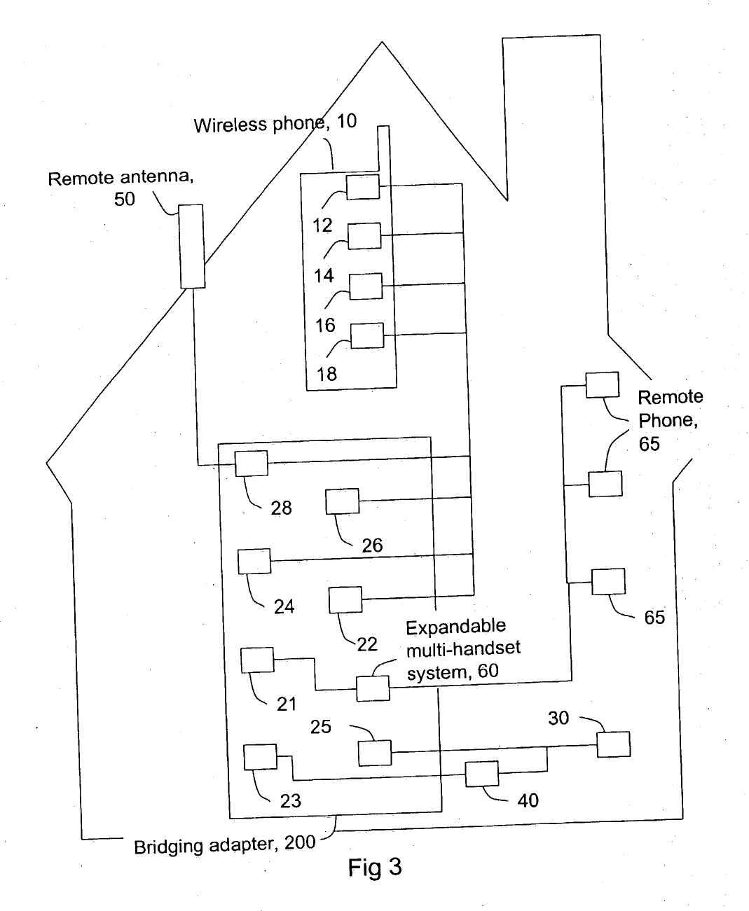

FIG. 3 illustrates another embodiment of the invention. In this embodiment, a plurality of remote phones 65 in an expandable multi-handset phone system 60 are connected to the wireless phone 10 via a connector 27 in the bridging adapter 200. In this embodiment, the bridging adapter 200 and multi-handset phone system 60 are integrated into a single unit. Other embodiments may separate the bridging adapter 200 and multi-handset phone system 60. Although the bridging adapter 200 in the second embodiment is connected in a slightly different fashion than in the first embodiment, the overall functionality of the bridging adapter 200 is generally the same in both embodiments.

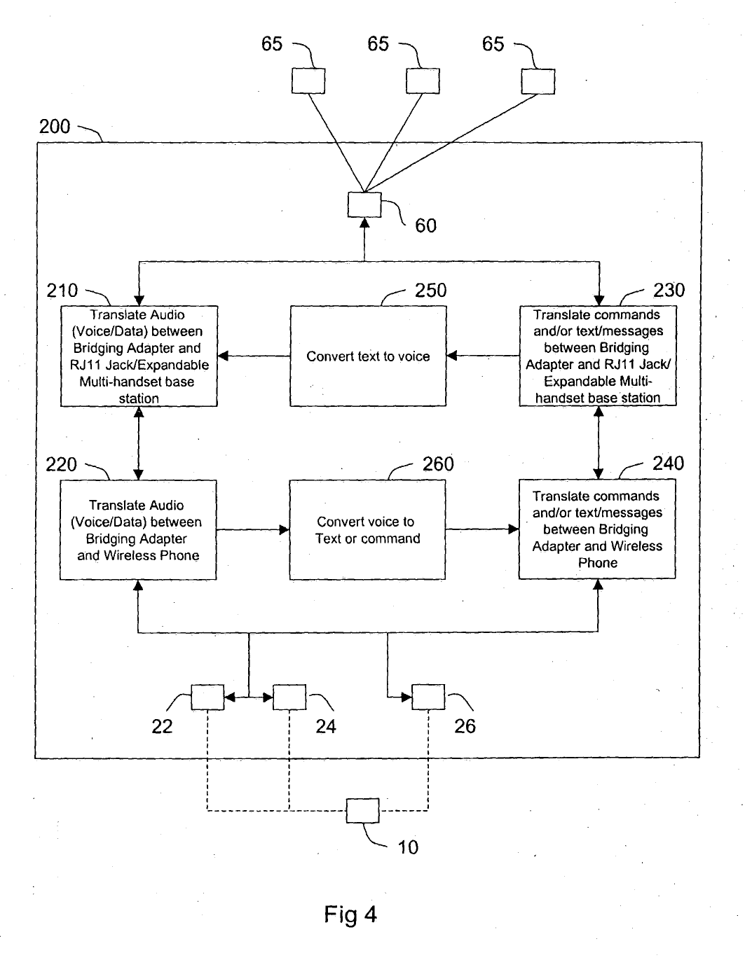

FIG. 4 illustrates six possible functions in the second bridging adapter 200 in the embodiment of this invention. The first function 210 translates audio (voice/data) signals between remote phones 65 of the expandable multi-handset system 60 and the second bridging adapter 200. This function 210 allows the translation of audio signals to and from any remote phones 65 of an expandable multi-handset system 60

The second function 220 translates audio (voice/data) signals between the bridging adapter 200 and the wireless phone 10. The wireless phone 10 is connected to the bridging adapter 200 through either hardwire connections via audio port 22 and control port 24 or through wireless connection via wireless port 26. This function 220 allows the translation of audio (voice/data) signals to and from any wireless telephone 10.

Audio signals from either function 210 or function 220 travel back and forth in real time in simplex or full duplex. This movement of audio signals between function 210 and function 220 provides audio communication between the wireless phone 10 and any remote phones 65 of an expandable multi-handset system 60.

The third function 230 translates commands and/or text/messages between the remote phones 65 of the expandable multi-handset system 60 and the bridging adapter 200. The plurality of commands includes, but is not limited to, ring function, caller ID display, message notification, dialing sequence activation, standard numerical dial tones, voice dialing, phone book search, phone number storage, phone answering, voicemail access, short messaging access, and termination of communication connection. The plurality of commands may include commands from the entire set or any subset of the available land-line telephone or wireless phone functions. This function 230 allows the translation of commands to activate, or communicate text to, remote phones 65 that are connected to the multi-handset phone system 60. This function 230 also allows the translations of commands and/or text/messages from the remote phones 65.

Commands and/or text/messages travel back and forth in real time between function 230 and function 240. This movement of commands and text/messages provides the operational commands and the passing of text/messages between the wireless phone 10 and the remote phones 65 of the expandable multi-handset system 60.

The fifth function 250 converts text/messages from function 230 to voice and sends the voice to function 210 for translation to remote phones 65 of the expandable multi-handset system 60. This function 250 can use text-to-voice technology to audibly transmit text/messages for remote phones 65 that cannot directly handle display of text/messages.

The sixth function 260 converts voice commands from function 220 to text or digital command and sends the commands to function 240 for translation to wireless phone 10. This function 260 can use voice recognition technology to translate audio/voice commands to digital commands that can be understood by the wireless phone.

The third embodiment of this invention is a combination of the first two embodiments. It uses an adapter that connects the wireless phone to both an extendable multi-handset system and land-line telephones through the telephony wiring network. This embodiment retains all the functionality of both the first and the second embodiments.

Various modifications and variations will no doubt occur to those skilled in the arts to which this invention pertains. For example, different levels of usage, integration and connection means between the wireless phone and the in-home phones or remote phones of extendable multi-handset systems may be varied. These and all other variations which basically rely on the teachings through which this disclosure has advanced the art are properly considered within the scope of this invention.

What is claimed is:

1. An adapter for connecting a wireless phone and a land line-based phone system, comprising:
a wired connector that connects the adapter to the land line-based phone system;
a communications connector that connects the adapter to the wireless phone; and
a translator that translates signals between the wireless phone and the land line phone.

2. The adapter of claim 1, wherein the land line-based phone system is a land line phone, and wherein the wired connector connects the adapter to a land line telephone jack.

3. The adapter of claim 1, wherein the land line-based phone system is an expandable multi-handset phone system having a base station connected to a land line telephone jack and a plurality of phones, and wherein the wired connector connects the adapter to the base station.

4. The adapter of claim 1, wherein the communications connector comprises:
an audio connector that connects with an audio port on the wireless phone; and
a control connector that connects with a control port on the wireless phone.

5. The adapter of claim 1, wherein the communications connector comprises a wireless communication link.

6. The adapter of claim 5, wherein the wireless communication link operates according to at least one standard selected from the group consisting of Bluetooth and 802.11.

7. The adapter of claim 1, further comprising an antenna adapter that connects with an antenna port on the wireless phone.

8. The adapter of claim 1, wherein the translator translates audio and command signals between the land-line telephone jack and the adapter, and translates audio and command signals between the adapter and the wireless phone.

9. The adapter of claim 8, wherein the translator further converts between text and audio.

10. The adapter of claim 1, wherein the signals translated at least one signal type selected from the group consisting of ring function, caller identification, message notification, dialing sequence activation, standard numerical dial tones, voice dialing, phone book search, phone number storage, phone answering, voicemail access, short messaging access, and termination of communication connection.

11. A multi-handset phone system comprising:
a plurality of remote phones;
a base station that communicates with the plurality of remote phones;
a wired connector that connects the base station to a phone jack; and
an adapter disposed in the base station for connecting a wireless phone to the base station, the adapter comprising
a communications connector that connects the adapter to the wireless phone; and
a translator that translates signals between the wireless phone and at least one of the remote phones.

12. The multi-handset phone system of claim 11, wherein the communications connector comprises:
an audio connector that connects with an audio port on the wireless phone; and
a control connector that connects with a control port on the wireless phone.

13. The multi-handset phone system of claim 11, wherein the communications connector comprises a wireless communication link.

14. The multi-handset phone system of claim 13, wherein the wireless communication link operates according to at least one standard selected from the group consisting of Bluetooth and 802.11.

15. The multi-handset phone system of claim 11, wherein the translator translates audio and command signals between the phone jack and the adapter, and translates audio and command signals between the adapter and the wireless phone.

16. The multi-handset phone system of claim 15, wherein the translator further converts between text and audio.

17. The multi-handset phone system of claim 11, wherein the adapter is also connected to at least one land-line telephone, and wherein the translator also translates signals between the wireless phone and said at least one land-line telephone.

18. The multi-handset phone system of claim 11, wherein the translator translates at least one signal type selected from the group consisting of ring function, caller identification, message notification, dialing sequence activation, standard numerical dial tones, voice dialing, phone book search, phone number storage, phone answering, voicemail access, short messaging access, and termination of communication connection.

19. A method for linking a wireless phone to a land line-based phone system, comprising:
exchanging audio and command signals between the wireless phone and the land line-based phone system;
translating the audio and command signals between a phone jack in the land line-based phone system and an adapter; and
translating the audio and command signals between the adapter and the wireless phone.

20. The method of claim 19, wherein the land line-based phone system is an expandable multi-handset phone system.

21. The method of claim 20, wherein the expandable multi-handset phone system comprises a plurality of phones, and wherein the translating steps translate between the wireless phone and at least one of said plurality of phones.

22. The method of claim 19, wherein the step of exchanging signals comprises exchanging the audio signals via an audio port on the wireless phone and exchanging the command signals via a control port on the wireless phone.

23. The method of claim 19, wherein the step of exchanging signals comprises exchanging the audio and command signals via a wireless communication link.

24. The method of claim 19, wherein the step of exchanging signals is conducted according to at least one standard selected from the group consisting of Bluetooth and 802.11.

25. The method of claim 19, further comprising the step of converting between text signals and audio signals.
